(19) United States
(12) Patent Application Publication
(10) Pub. No.: US 2007/0197690 A1
(43) Pub. Date: Aug. 23, 2007

(54) Additive building material mixtures containing sterically or electrostatically repulsive monomers in the microparticles' shell

(75) Inventors: Jan Hendrik Schattka, Hanau (DE); Holger Kautz, Hanau (DE); Gerd Loehden, Hanau (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: ROEHM GBMH & CO. KG, Darmstadt (DE)

(21) Appl. No.: 11/388,040

(22) Filed: Mar. 24, 2006

(30) Foreign Application Priority Data
Feb. 23, 2006 (DE) 2006 008 963.4

(51) Int. Cl. C04B 24/26

(52) U.S. Cl. 524/2

(57) ABSTRACT

The present invention relates to the use of polymeric microparticles whose shells contain additional monomers for the electrostatic and/or steric repulsions of the microparticles, in hydraulically setting building material mixtures for the purpose of enhancing their frost resistance and cyclical freeze/thaw durability.

The present invention relates to the use of polymeric microparticles in hydraulically setting building material mixtures for the purpose of enhancing their frost resistance and cyclical freeze/thaw durability.

Concrete is an important building material and is defined by DIN 1045 (07/1988) as artificial stone formed by hardening from a mixture of cement, aggregate and water, together where appropriate with concrete admixtures and concrete additions. One way in which concrete is classified is by its subdivision into strength groups (BI-BII) and strength classes (B5-B55). Mixing in gas-formers or foam-formers produces aerated concrete or foamed concrete (Rompp Lexikon, 10th ed., 1996, Georg Thieme Verlag).

Concrete has two time-dependent properties. Firstly, by drying out, it undergoes a reduction in volume that is termed shrinkage. The majority of the water, however, is bound in the form of water of crystallization. Concrete, rather than drying, sets: that is, the initially highly mobile cement paste (cement and water) starts to stiffen, becomes rigid, and, finally, solidifies, depending on the timepoint and progress of the chemical/mineralogical reaction between the cement and the water, known as hydration. As a result of the water-binding capacity of the cement it is possible for concrete, unlike quicklime, to harden and remain solid even under water. Secondly, concrete undergoes deformation under load, known as creep.

The freeze/thaw cycle refers to the climatic alternation of temperatures around the freezing point of water. Particularly in the case of mineral-bound building materials such as concrete, the freeze/thaw cycle is a mechanism of damage. These materials possess a porous, capillary structure and are not watertight. If a structure of this kind that is full of water is exposed to temperatures below 0° C., then the water freezes in the pores. As a result of the density anomaly of water, the ice then expands. This results in damage to the building material. Within the very fine pores, as a result of surface effects, there is a reduction in the freezing point. In micropores water does not freeze until below −17° C. Since, as a result of freeze/thaw cycling, the material itself also expands and contracts, there is additionally a capillary pump effect, which further increases the absorption of water and hence, indirectly, the damage. The number of freeze/thaw cycles is therefore critical with regard to damage.

Decisive factors affecting the resistance of concrete to frost and to cyclical freeze/thaw under simultaneous exposure to thawing agents are the imperviousness of its microstructure, a certain strength of the matrix, and the presence of a certain pore microstructure. The microstructure of a cement-bound concrete is traversed by capillary pores (radius: 2 μm-2 mm) and gel pores (radius: 2-50 nm). Water present in these pores differs in its state as a function of the pore diameter. Whereas water in the capillary pores retains its usual properties, that in the gel pores is classified as condensed water (mesopores: 50 nm) and adsorptively bound surface water (micropores: 2 nm), the freezing points of which may for example be well below −50° C. [M. J. Setzer, Interaction of water with hardened cement paste, Ceramic Transactions 16 (1991) 415-39]. Consequently, even when the concrete is cooled to low temperatures, some of the water in the pores remains unfrozen (metastable water). For a given temperature, however, the vapour pressure over ice is lower than that over water. Since ice and metastable water are present alongside one another simultaneously, a vapour-pressure gradient develops which leads to diffusion of the still-liquid water to the ice and to the formation of ice from said water, resulting in removal of water from the smaller pores or accumulation of ice in the larger pores. This redistribution of water as a result of cooling takes place in every porous system and is critically dependent on the type of pore distribution.

The artificial introduction of microfine air pores in the concrete hence gives rise primarily to what are called expansion spaces for expanding ice and ice-water. Within these pores, freezing water can expand or internal pressure and stresses of ice and ice-water can be absorbed without formation of microcracks and hence without frost damage to the concrete. The fundamental way in which such air-pore systems act has been described, in connection with the mechanism of frost damage to concrete, in a large number of reviews [Schulson, Erland M. (1998) Ice damage to concrete. CRREL Special Report 98-6; S. Chatterji, Freezing of air-entrained cement-based materials and specific actions of air-entraining agents, Cement & Concrete Composites 25 (2003) 759-65; G. W. Scherer, J. Chen & J. Valenza, Methods for protecting concrete from freeze damage, U.S. Pat. No. 6,485,560 B1 (2002); M. Pigeon, B. Zuber & J. Marchand, Freeze/thaw resistance, Advanced Concrete Technology 2 (2003) 11/1-11/17; B. Erlin & B. Mather, A new process by which cyclic freezing can damage concrete—the Erlin/Mather effect, Cement & Concrete Research 35 (2005) 1407-11].

A precondition for improved resistance of the concrete on exposure to the freezing and thawing cycle is that the distance of each point in the hardened cement from the next artificial air pore does not exceed a defined value. This distance is also referred to as the “Powers spacing factor” [T. C. Powers, The air requirement of frost-resistant concrete, Proceedings of the Highway Research Board 29 (1949) 184-202]. Laboratory tests have shown that exceeding the critical “Powers spacing factor” of 500 μm leads to damage to the concrete in the freezing and thawing cycle. In order to achieve this with a limited air-pore content, the diameter of the artificially introduced air pores must therefore be less than 200-300 μm [K. Snyder, K. Natesaiyer & K. Hover, The stereological and statistical properties of entrained air voids in concrete: A mathematical basis for air void systems characterization, Materials Science of Concrete VI (2001) 129-214].

The formation of an artificial air-pore system depends critically on the composition and the conformity of the aggregates, the type and amount of the cement, the consistency of the concrete, the mixer used, the mixing time, and the temperature, but also on the nature and amount of the agent that forms the air pores, the air entrainer. Although these influencing factors can be controlled if account is taken of appropriate production rules, there may nevertheless be a multiplicity of unwanted adverse effects, resulting ultimately in the concrete's air content being above or below the desired level and hence adversely affecting the strength or the frost resistance of the concrete.

Artificial air pores of this kind cannot be metered directly; instead, the air entrained by mixing is stabilized by the addition of the aforementioned air entrainers [L. Du & K. J. Folliard, Mechanism of air entrainment in concrete, Cement & Concrete Research 35 (2005) 1463-71]. Conventional air entrainers are mostly surfactant-like in structure and break up the air introduced by mixing into small air bubbles having a diameter as far as possible of less than 300 μm, and stabilize them in the wet concrete microstructure. A distinction is made here between two types.

One type—for example sodium oleate, the sodium salt of abietic acid or Vinsol resin, an extract from pine roots—reacts with the calcium hydroxide of the pore solution in the cement paste and is precipitated as insoluble calcium salt. These hydrophobic salts reduce the surface tension of the water and collect at the interface between cement particle, air and water. They stabilize the microbubbles and are therefore encountered at the surfaces of these air pores in the concrete as it hardens.

The other type—for example sodium lauryl sulfate (SDS) or sodium dodecyl-phenylsulphonate—reacts with calcium hydroxide to form calcium salts which, in contrast, are soluble, but which exhibit an abnormal solution behaviour. Below a certain critical temperature the solubility of these surfactants is very low, while above this temperature their solubility is very good. As a result of preferential accumulation at the air/water boundary they likewise reduce the surface tension, thus stabilize the microbubbles, and are preferably encountered at the surfaces of these air pores in the hardened concrete.

The use of these prior-art air entrainers is accompanied by a host of problems [L. Du & K. J. Folliard, Mechanism of air entrainment in concrete, Cement & Concrete Research 35 (2005) 1463-71]. For example, prolonged mixing times, different mixer speeds and altered metering sequences in the case of ready-mix concretes result in the expulsion of the stabilized air (in the air pores).

The transporting of concretes with extended transport times, poor temperature control and different pumping and conveying equipment, and also the introduction of these concretes in conjunction with altered subsequent processing, jerking and temperature conditions, can produce a significant change in an air-pore content set beforehand. In the worst case this may mean that a concrete no longer complies with the required limiting values of a certain exposure class and has therefore become unusable [EN 206-1 (2000), Concrete—Part 1: Specification, performance, production and conformity].

The amount of fine substances in the concrete (e.g. cement with different alkali content, additions such as flyash, silica dust or colour additions) likewise adversely affects air entrainment. There may also be interactions with flow improvers that have a defoaming action and hence expel air pores, but may also introduce them in an uncontrolled manner.

A further disadvantage of the introduction of air pores is seen as being the decrease in the mechanical strength of the concrete with increasing air content.

All of these influences which complicate the production of frost-resistant concrete can be avoided if, instead of the required air-pore system being generated by means of abovementioned air entrainers with surfactant-like structure, the air content is brought about by the admixing or solid metering of polymeric microparticles (hollow microspheres) [H. Sommer, A new method of making concrete resistant to frost and de-icing salts, Betonwerk & Fertigteiltechnik 9 (1978) 476-84]. Since the microparticles generally have particle sizes of less than 100 μm, they can also be distributed more finely and uniformly in the concrete microstructure than can artificially introduced air pores. Consequently, even small amounts are sufficient for sufficient resistance of the concrete to the freezing and thawing cycle.

The use of polymeric microparticles of this kind for improving the frost resistance and cyclical freeze/thaw durability of concrete is already known from the prior art [cf. DE 2229094 A1, U.S. Pat. No. 4,057,526 B1, U.S. Pat. No. 4,082,562 B1, DE 3026719 A1]. The microparticles described therein have diameters of at least 10 μm (usually substantially larger) and possess air-filled or gas-filled voids. This likewise includes porous particles, which can be larger than 100 μm and may possess a multiplicity of relatively small voids and/or pores.

With the use of hollow microparticles for artificial air entrainment in concrete, two factors proved to be disadvantageous for the implementation of this technology on the market. On the one hand, the production costs of hollow microspheres according to the prior art are too high, and, on the other hand, relatively high doses are required in order to achieve satisfactory resistance of the concrete to freezing and thawing cycles. The object on which the present invention is based was therefore that of providing a means of improving the frost resistance and cyclical freeze/thaw durability for hydraulically setting building material mixtures that develops its full activity even in relatively low doses. A further object was that this means should not, or not substantially, detract from the mechanical strength of the building material mixture.

The object has been achieved through the use of polymeric microparticles, containing a void, in hydraulically setting building material mixtures, characterized in that in the shell of the microparticles monomers are used which contribute to the electrostatic and/or steric repulsion or stabilization of the particles.

Surprisingly it has been found that the amount of emulsifier needed for preparation, transport and storage of the microparticles can be greatly reduced through the use of comonomers which bring about electrostatic and/or steric repulsion.

A reduced amount of emulsifier leads in turn to a lower air input into the building material mixtures, and hence to less of an adverse effect on the mechanical strength of the cured building material mixture.

It has been found that for the purpose of electrostatic repulsion of the microparticles, advantageously, free-radically polymerizable monomers are copolymerized into the shell, where appropriate into the outer shell, that carry at least one acid group. Preference is given to using ethylenically unsaturated carboxylic acids, their derivatives or mixtures thereof. Particular preference is given to monomers selected from the group of acrylic acid, methacrylic acid, maleic acid, maleic anhydride, fumaric acid, itaconic acid and crotonic acid and mixtures thereof.

Additionally it has been found that by means of corresponding monomers in the shell—where appropriate in the outer shell—it is also possible to bring about the steric repulsion of the microparticles. Preference is given to free-radically polymerizable monomers having a molar mass of greater than 200 g/mol which carry a hydrophilic radical. Particular preference is given to monomers which carry a polyethylene oxide block with two or more units of ethylene oxide. It is preferred to use monomers from the group of (meth)acrylic esters of methoxypolyethylene glycol CH₃O(CH₂CH₂O)ₙH (with n>2), (meth)acrylic esters of an ethoxylated C16-C18 fatty alcohol mixture (with 2 or more ethylene oxide units), methacrylic esters of 5-tert-octylphenoxypolyethoxyethanol (with 2 or more ethylene oxide units), nonylphenoxypolyethoxyethanol (with 2 or more ethylene oxide units) or mixtures thereof are used.

The (meth)acrylate notation here denotes not only methacrylate, such as methyl methacrylate, ethyl methacrylate, etc., but also acrylate, such as methyl acrylate, ethyl acrylate, etc., and also mixtures of both.

The microparticles of the invention can be prepared preferably by emulsion polymerization and preferably have an average particle size of 100 to 5000 nm; an average particle size of 200 to 2000 nm is particularly preferred. Maximum preference is given to average particle sizes of 250 to 1000 nm.

The average particle size is determined for example by counting a statistically significant amount of particles by means of transmission electron micrographs.

In the case of preparation by emulsion polymerization the microparticles are obtained in the form of an aqueous dispersion. Correspondingly the addition of the microparticles to the building material mixture takes place likewise preferably in this form.

Microparticles of this kind are already known in the prior art and are described in the publications EP 22 633 B1, EP 73 529 B1 and EP 188 325 B1. Furthermore, these microparticles are sold commercially under the brand name ROPAQUE® by Rohm & Haas. These products have to date been used primarily in inks and paints for improving the hiding power and opacity of paint coats or prints on paper, boards and other materials.

In the course of preparation and in the dispersion the voids in the microparticles are water-filled. Without restricting the invention to this effect, it is assumed that the water is at least partly relinquished by the particles as the building material mixture hardens, giving correspondingly gas-filled or air-filled hollow spheres.

This process also takes place, for example, when microparticles of this kind are used in paints.

According to one preferred embodiment the microparticles used are composed of polymer particles which possess a core (A) and at least one shell (B), the core/shell polymer particles having been swollen by means of a base.

The core (A) of the particle contains one or more ethylenically unsaturated carboxylic acid (derivative) monomers which permit swelling of the core; these monomers are preferably selected from the group of acrylic acid, methacrylic acid, maleic acid, maleic anhydride, fumaric acid, itaconic acid and crotonic acid and mixtures thereof. Acrylic acid and methacrylic acid are particularly preferred.

The shell (B) predominantly of nonionic, ethylenically unsaturated monomers. As such monomers use is made preferably of styrene, butadiene, vinyltoluene, ethylene, vinyl acetate, vinyl chloride, vinylidene chloride, acrylonitrile, acrylamide, methacrylamide and/or C1-C12 alkyl esters of (meth)acrylic acid or mixtures thereof.

The polymer envelope (B) is admixed in accordance with the invention with 0.5%-30% by weight of monomers which cause electrostatic or steric repulsion of the microparticles. It is particularly preferred to add 0.8%-18% by weight of these monomers; still more preferred is the addition of 1%-10% by weight.

The preparation of these polymeric microparticies by emulsion polymerization and their swelling by means of bases such as alkali or alkali metal hydroxides and also ammonia or an amine are likewise described in European patents EP 22 633 B1, EP 735 29 B1 and EP 188 325 B1.

It is possible to prepare core-shell particles which have a single-shell or multi-shell construction, or whose shells exhibit a gradient.

The polymer content of the microparticles used may be situated—as a function, for example, of the diameter, the core/shell ratio and the swelling efficiency—at 2% to 98% by weight.

Whereas the water-filled, polymeric microparticles are used preferably in accordance with the invention in the form of an aqueous dispersion, it is entirely possible, within the scope of the present invention, to add the water-filled microparticles directly as a solid to the building material mixture. For that purpose the microparticles are for example—by methods known to the skilled person—coagulated and isolated from the aqueous dispersion by standard methods (e.g. filtration, centrifugation, sedimentation and decanting). The material obtained can be washed in order to achieve a further reduction in the surfactant content, and is subsequently dried.

The water-filled microparticles are added to the building material mixture in a preferred amount of 0.01% to 5% by volume, in particular 0.1% to 0.5% by volume. The building material mixture—in the form for example of concrete or mortar—may in this case include the customary hydraulically setting binders, such as cement, lime, gypsum or anhydrite, for example.

Through the use of the microparticles of the invention it is possible to keep the input of air into the building material mixture extremely low.

On concrete, for example, improvements in the compressive strengths of more than 35% have been found, compared with concrete obtained with conventional air-pore formation.

Higher compressive strengths are of interest not least, and in particular, since they make It possible to reduce the amount of cement in concrete that is needed for the development of strength, so making it possible to achieve a significant reduction in the price per m³ of concrete.

1. Use of polymeric microparticles, containing a void, in hydraulically setting building material mixtures, characterized in that in the shell of the microparticles monomers are used which contribute to the electrostatic and/or steric repulsion of the microparticles.

2. Use of polymeric microparticles, containing a void, according to claim 1, characterized in that the monomers in the shell that contribute to the repulsion of the particles are free-radically polymereizable compounds which carry at least one acid group.

3. Use of polymeric microparticles, containing a void, according to claim 2, characterized in that the monomers in the shell that contribute to the repulsion of the particles are ethylenically unsaturated carboxylic acids, their derivatives or mixtures thereof.

4. Use of polymeric microparticles, containing a void, according to claim 3, characterized in that the monomers in the shell that contribute to the repulsion of the particles are selected from the group of acrylic acid, methacrylic acid, maleic acid, maleic anhydride, fumaric acid, itaconic acid and crotonic acid and mixtures thereof.

5. Use of polymeric microparticles, containing a void, according to claim 1, characterized in that free-radically polymerizable monomers which carry a hydrophilic radical having a molar mass of greater than 200 g/mol are used.

6. Use of polymeric microparticles, containing a void, according to claim 5, characterized in that free-radically polymerizable monomers selected from the group of (meth)acrylic esters of methoxypolyethylene glycol CH₃O(CH₂CH₂O)ₙH (with n≧2), (meth)acrylic esters of an ethoxylated C16-C18 fatty alcohol mixture (with 2 or more ethylene oxide units) methacrylic esters of 5-tert-octylphenoxypolyethoxyethanol (with 2 or more ethylene oxide units), nonylphenoxypolyethoxyethanol (with 2 or more ethylene oxide units) or mixtures thereof are used.

7. Use of polymeric microparticles, containing a void, according to claim 1, characterized in that the microparticles are composed of polymer particles which comprise a polymer core (A), which is swollen by means of an aqueous base, based on an unsaturated carboxylic acid (derivative) monomer, and a polymer envelope (B), based on a nonionic, ethylenically unsaturated monomer.

8. Use of polymeric microparticles, containing a void, according to any one of claims 1 to 7, characterized in that the monomers that contribute to the repulsion of the particles account for 0.5%-30% by weight of monomers forming the shell polymer.

9. Use of polymeric microparticles, containing a void, according to claim 8, characterized in that the monomers that contribute to the repulsion of the particles account for 0.8%-20% by weight of the monomers forming the shell polymer.

10. Use of polymeric microparticles, containing a void, according to claim 9, characterized in that the monomers that contribute to the repulsion of the particles account for 1%-10% by weight of the monomers forming the shell polymer.

11. Use of polymeric microparticles, containing a void, according to claim 1, characterized in that the microparticles have a polymer content of 2% to 98% by weight.

12. Use of polymeric microparticles, containing a void, according to claim 1, characterized in that the microparticles have an average particle size of 100 to 5000 nm.

13. Use of polymeric microparticles, containing a void, according to claim 12, characterized in that the microparticles have an average particle size of 200 to 2000 nm.

14. Use of polymeric microparticles, containing a void, according to claim 13, characterized in that the microparticles have an average particle size of 250 to 1000 nm.

15. Use of polymeric microparticles, containing a void, according to claim 1, characterized in that the microparticles are used in an amount of 0.01% to 5% by volume, based on the building material mixture.

16. Use of polymeric microparticles, containing a void, according to claim 15, characterized in that the microparticles are used in an amount of 0.1% to 0.5% by volume, based on the building material mixture.

17. Use of polymeric microparticles, containing a void, according to claim 1, characterized in that the building material mixtures are composed of a binder selected from the group of cement, lime, gypsum and anhydrite.

18. Use of polymeric microparticles, containing a void, according to claim 1, characterized in that the building material mixtures are concrete or mortar.
